(19) United States
(12) Patent Application Publication
(10) Pub. No.: US 2005/0021191 A1
(43) Pub. Date: Jan. 27, 2005

(54) Environment conservation contribution system

(75) Inventors: Makoto Taniguchi, Obu-city (JP); Akira Kato, Kani-city (JP); Katsunori Tanaka, Haguri-gun (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 10/864,366

(22) Filed: Jun. 10, 2004

(30) Foreign Application Priority Data
Jul. 11, 2003 (JP) 2003-273790

(51) Int. Cl. G06F 7/00

(52) U.S. Cl. 701/1; 701/36

(57) ABSTRACT

An in-vehicle generator is caused to start regenerative generation when the regenerative generation is possible. This regenerative generation can decrease a generation amount under a vehicle traveling state where fuel is consumed and exhaust gas is emitted, thereby decreasing a load of an engine and amounts of fuel consumption and exhaust emission. The fuel consumption or exhaust emission to be decreased is computed and transmitted to a managing center via an in-vehicle wireless terminal. The managing center provides a driver with a reward such as a service corresponding to the decreased amount of fuel consumption or exhaust emission that is computed in the relevant vehicle. This system enables the regenerative generation to be returned to the driver as an economic value, motivating the driver to decrease the fuel consumption or exhaust emission. This thereby contributes to the conservation of global environment.

### CROSS REFERENCE TO RELATED APPLICATIONS

This application is based on and incorporates herein by reference Japanese Patent Application No. 2003-273790 filed on Jul. 11, 2003.

### FIELD OF THE INVENTION

The present invention relates to an environment conservation contribution system contributing to global environment conservation, an in-vehicle device providing a decreased amount of fuel consumption or exhaust emission to a managing center, a regenerative generation utilization system, and a method for returning a value of regenerative generation.

### BACKGROUND OF THE INVENTION

In JP-H8-266097 A, a technology is described that prevents an alternator from maximally generating power when an electrical load is connected so that decrease of an engine speed or decrease of driving performance can be restricted. In JP-S59-57130 A, a technology is described that returns generation power of a test motor to a public power line or a private power generation so as to recover energy. Further, in JP-2002-230696, a vehicle traveling information management system is described. Here, vehicle traveling information is sent from an in-vehicle terminal to a sever; the server determines a vehicle traveling state to compute a reward/punishment to be provided; then, the resulting reward/punishment is sent to the relevant vehicle.

In JP-H8-266097 A, a generation state is varied according to a vehicle state; however, generation power during the regeneration is not utilized. In JP-S59-57130 A, the motor must be constantly connected with the power line for recovering the energy. In JP-2002-230696, to retrieve the vehicle traveling state a large amount of data needs dealing with, so that the system eventually becomes large.

### SUMMARY OF THE INVENTION

It is a first object of the present invention to provide an environment conservation contribution system where a vehicle owner is rewarded for a decreased amount of fuel consumption or exhaust emission corresponding to a decreased amount of generation power decreased by regenerative generation, resulting in contribution to global environment conservation.

It is a second object of the present invention to provide an in-vehicle device enabling the vehicle owner to be rewarded for a decreased amount of fuel consumption or exhaust emission corresponding to a decreased amount of generation power decreased by regenerative generation.

It is a third object of the present invention to provide a regenerative generation utilization system selling and utilizing power generated in regeneration.

It is a fourth object of the present invention to provide a method for returning a value of regenerative generation enabling a right holder to use an economic value according to regenerative generation.

To achieve the above objects, a vehicle is provided with the following. Certain generating means is disposed for executing regenerative generation. Electric power accumulating means is disposed for accumulating electric power owing to at least the regenerative generation executed by the certain generating means and for functioning as a supply source of operational electric power for an electric load disposed in the vehicle. Regenerative generation determining means is disposed for monitoring a state of the vehicle and for determining whether the regenerative generation executed by the certain generating means is allowed under the state monitored. Generation controlling means is disposed for causing the certain generating means to execute the regenerative generation when the regenerative generation is determined to be allowed under the state monitored. Data providing means is disposed for providing, to a managing center outside the vehicle, data corresponding to the regenerative generation executed.

In the above structure, under the state where the regenerative generation is allowed, namely, where kinetic energy of the vehicle can be converted into electric energy, the generation controlling means causes the generator to execute the regenerative generation without consuming fuel. Further, data corresponding to the regenerative generation executed is provided to an outside managing center, so that via the managing center a value corresponding to the regenerative generation executed can be returned to an owner of the vehicle.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram of an in-vehicle device constituting an environment conservation contribution system according to a first embodiment of the present invention;

FIG. 2 is a flow chart diagram of an operation of a controller of the environment conservation contribution system of the first embodiment;

FIG. 3 is a block diagram of an environment conservation contribution system according to the first embodiment;

FIG. 4 is a block diagram of an in-vehicle device constituting an environment conservation contribution system according to a second embodiment of the present invention;

FIG. 5 is a flow chart diagram of an operation of a controller of the environment conservation contribution system of the second embodiment;

FIG. 6 is a block diagram of an environment conservation contribution system according to the second embodiment;

FIG. 7 is a block diagram of an in-vehicle device constituting an environment conservation contribution system according to a third embodiment of the present invention;

FIG. 8 is a block diagram of an in-vehicle device of a regenerative generation utilization system according to a fourth embodiment of the present invention;

FIG. 9 is a flow chart diagram of an operation of a controller of the regenerative generation utilization system according to the fourth embodiment;

FIG. 10 is a time chart diagram of an operation of a large-current contact of the regenerative generation utilization system according to the fourth embodiment; and

FIG. 11 is a block diagram of an in-vehicle device constituting an environment conservation contribution system according to a fifth embodiment of the present invention.

### DETAILED DESCRIPTION OF THE PREFERRED EMBODIMENTS

An object of contribution to global environment conservation is achieved by regenerative (power) generation in a vehicle. The regenerative generation is executed not by using fuel but by recovering (or regenerating) kinetic energy of the vehicle, energy derived from exhaust gas of the vehicle, etc. A generation amount is increased under a state (regeneration-enabled state) where the regenerative generation is allowed. This is referred to as a generation increasing control under a regeneration-enabled state. A generation amount is restrained or stopped to decrease an engine load under a normal state (non-regenerative or regeneration-disabled state), where a normal generation using fuel takes place and the regenerative generation is not allowed. This is referred to as a generation decreasing control under a state other than the regeneration-enabled state. Fuel consumption and exhaust emission are decreased using both of the generation increasing control under the regeneration-enabled state and the generation decreasing control under the regeneration-disabled state. A vehicle owner is rewarded with value exchange corresponding to the decreased amount of the fuel consumption or exhaust emission.

A vehicle has a generator for converting, to electric power, energy accompanying decelerating of a vehicle under a given condition. The generator can be a so-called motor generator also functioning as an electric motor. The vehicle is provided with a regenerative generation determining means for determining whether regenerative (electric power) generation is allowed or not. When the regenerative generation is allowed, the regenerative generation determining means causes the generator to execute regenerative generation. The electric power generated by the regenerative generation is charged to a battery and then consumed, or is directly consumed, e.g., through supplying to an electrical load.

As a result, when the generator is driven by an in-vehicle engine using fossil fuel such as gasoline or diesel oil, a certain amount of electric power is obtained under regenerative generation by the generator without being driven by the in-vehicle engine. The electric power obtained from the regenerative generation eventually decreases the generation obtained by the motive energy of the engine, which contributes to decrease in fuel supply or exhaust emission.

When a vehicle travels by driving the motor generator using battery or fuel battery as an energy source, the electric power obtained from the regenerative generation is consumed within the relevant vehicle. This decreases a power charge amount to the battery from a commercial power source or supply of hydrogen fuel to the fuel battery. The decreased amount of fuel consumption, exhaust emission, power charge, or hydrogen fuel can be regarded as contribution activity to resource saving or as an index indicating a contribution amount for decreasing an environment load.

Data of the above decreased amount is accumulated within an in-vehicle device, or is directly transmitted to a managing center. The managing center returns reward or privilege (preferential treatment) to a previously registered driver or vehicle owner, according to the decreased amount.

When an in-vehicle device is securely maintained in its security, the in-vehicle device can directly convert the decreased amount into a reward having an economic value. This reward can include, to a road toll, a supplement or a discount necessary while the relevant vehicle is traveling or in an operation.

When the decreased amount is handled by the managing center, the center converts the decreased amount into a reward having an economic value and accumulates the reward. The reward can be managed as a service, a price, a goods, or points changeable with the foregoing. The managing center provides the managed reward based on a request from a person having a right to receive the reward. For instance, the managing center provides, as the reward, points added according to a usage amount in a credit card, or mileage points added according to a usage amount in an airline.

A source for the above reward having an economic value is, for instance, a CO₂ decrease amount into which the decreased amount of fuel consumption is converted, a subsidy or contribution from a government or companies, funds from companies participating in this system, an advertising income etc. This can achieve an environment conservation contribution system where the economic value corresponding to the regenerative generation is returned to a driver or owner of a relevant vehicle.

The vehicle is provided with an in-vehicle device capable of outwardly transmitting data of the regenerative generation amount. Providing this type of vehicle enables the driver to directly receive a reward to the regenerative generation, motivating the driver to be interested in the regenerative generation and fuel saving as its advantage.

Operating this environment conservation contribution system leads the driver to expect the economic value as the reward to thereby make efforts in driving the vehicle so that a regenerative generation amount can be increased. Thus, operating the environment conservation contribution system enabling the regenerative generation amount to be returned to the driver or owner as the economic value motivates fuel consumption or exhaust emission decreasing activity, encouraging this decreasing activity to thereby contribute to the conservation of global environment.

(First Embodiment)

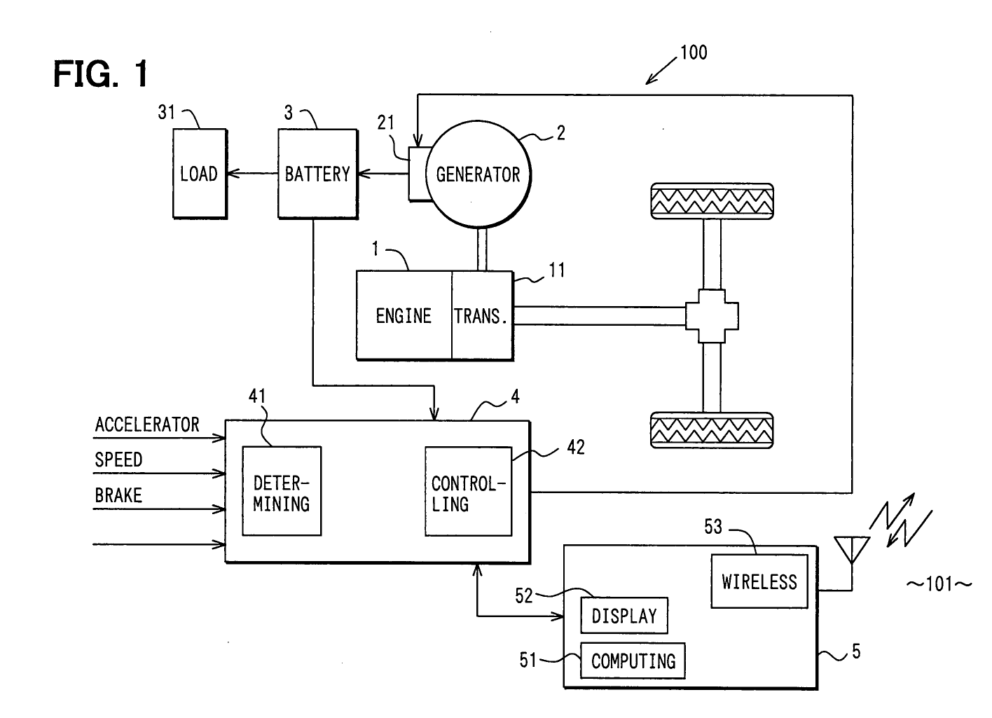

An environment conservation contribution system 100 according to a first embodiment of the present invention will be now explained with reference to FIGS. 1 to 3. The system 100 is constructed of a vehicle 101 constituting a power generation and power consumption systems, and a base station that is constructed to be communicated with the vehicle 101 and deals with data having an economic value under certain security.

The vehicle 101 includes an in-vehicle engine 1; an in-vehicle generator 2; an in-vehicle battery 3 as an electric power storage accumulating or storing electric power; a controller 4 having a regenerative generation determining means 41 for determining whether regenerative (power) generation is allowed and a generation controlling means 42 for controlling a generation amount of a generator 2; a decreased amount computing means 51; a displaying means 52; and an electronic toll collection system (ETC) in-vehicle device 5 having a wireless terminal 53. The base station is included in a managing center 6.

Decreased amount data is provided from the vehicle 101 to the center 6 via wireless communications. In this embodiment, the ETC in-vehicle device 5 contains the decreased amount computing means 51, the displaying means 52, and the wireless terminal 53 within its housing.

The engine 1 operates using gasoline mounted inside the vehicle 101, primarily generating power for traveling. The generator 2 is an alternator enabling variation of the generation amount by varying exciting current, being connected with the engine 1 via a transmission 11. The battery 3 stores electric power generated by the generator 2, supplying electrical loads 31 such as in-vehicle electronic devices with operational power.

The regenerative generation determining means 41 monitors a traveling state of the vehicle 101 based on inputted accelerator opening signals, vehicle speed signals, and brake signals, thereby determining whether power regeneration (or regenerative generation) is possible. The traveling state enabling the power regeneration (or referred to as “regeneration-enabled state”) includes a state where a foot is separated from an accelerator, e.g., corresponding to running by inertia, decelerating, braking, and descending.

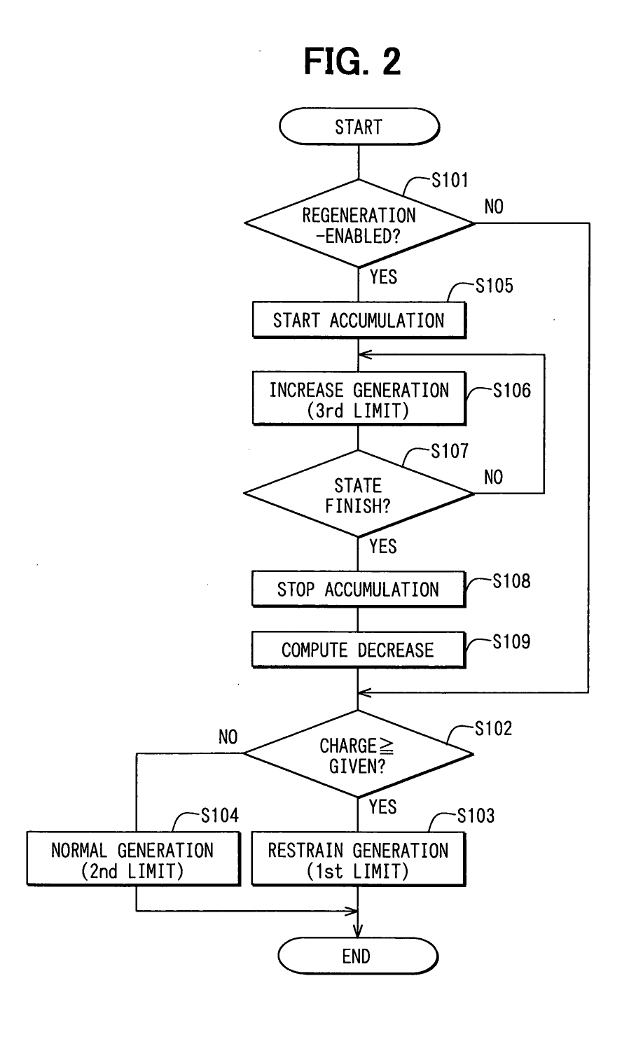

The generation controlling means 42 instructs a regulator 21 to vary the exciting current within a range up to each upper limit for controlling the generation amount of the generator 2 under the traveling states to be described below. FIG. 2 shows a flow chart diagram of an operation of the generation controlling means 42.

Under Regeneration-Enabled State

When, at Step S101, the regenerative generation determining means 41 determines that a traveling state is capable of power regeneration (or a regeneration-enabled state), the process branches into “YES.” Here, the generation controlling means 42 sets an upper limit of the exciting current to the third upper limit being higher than the second limit (to be later described) until the regeneration-enabled state finishes.

The controlling means 42 performs a rapid charging, namely, generates the generator 2 in large-amount generation by varying the exciting current within the range up to the third upper limit so that the battery 3 can reach or approach voltage V3 in its terminal voltage to become fully charged. The voltage V3 is, for instance, 15V. This operation is shown in Step S106.

Under Regeneration-Disabled State and Favorable Charging State

When, at Step S101, the regenerative generation determining means 41 determines that a traveling state is not capable of power regeneration (or that a traveling state is a regeneration-disabled state), the process branches into “NO.” Additionally, when, at Step S102, it is determined that a charging state is not less than a given amount, the process branches to “YES.” Here, the generation controlling means 42 executes Step S103, namely, restrains the generation amount by setting the upper limit of the exciting current to the first upper limit. Here, the controlling means 42 restrains or stops the generation of the generator 2 by varying the exciting current within the range up to the first upper limit so that the battery 3 can reach or approach specific voltage V1 in its terminal voltage. The voltage V1 is, for instance, 12V. This operation is shown in Step S103. Further, it is supposed that even when charging state is not less than the given amount, consumption power is large owing to operation of the electrical load 31 such as headlight and air-conditioner. Here, the charging state may become short, so that the upper limit of the exciting current is favorably set to the second upper limit being higher than the first upper limit.

Under Regeneration-Disabled State and Short Charging State

When, at Step S101, the regenerative generation determining means 41 determines that a traveling state is not capable of power regeneration, the process branches into “NO.” Additionally, when, at Step 102, it is determined that charging state is less than the given amount, the process branches to “NO.” Here, the generation controlling means 42 executes Step S104. Here, the controlling means 42 sets the upper limit of the exciting current to the second upper limit being higher than the first upper limit.

The controlling means 42 then normally generates the generation of the generator 2 by varying the exciting current within the range up to the second upper limit so that the battery 3 can reach or approach specific voltage V2 in its terminal voltage and is prevented from running out. The voltage V2 is, for instance, 13V. The voltages V1, V2, V3 can be varied as needed as long as V1<V2<V3.

In the vehicle 101 of the contribution system 100 of this embodiment, the controlling means 42 executes, in regenerative generation, a generation increasing control shown at Step 106 for fully charging the battery 3; when the power regeneration is unavailable and the charging state is favorable, the controlling means 42 executes a generation decreasing control shown at Step 103 for decreasing the fuel consumption amount and exhaust emission amount by relieving the engine load. In this embodiment, the traveling state where the engine 1 consumes fuel and emits exhaust gas is regarded as the regeneration-disabled state disabling regeneration, which is the state other than the regeneration-enabled state enabling power regeneration. Namely, in the regeneration-disabled state the generation decreasing control is executed.

The decreased amount computing means 51 computes the decreased amount of fuel consumption or exhaust emission by the procedure described below. In FIG. 2, when the determining means 41 determines that the state is capable of power regeneration, the process branches to “YES” at Step S101 and advances to Step S105, where a regeneration-enabled signal is outputted to the ETC in-vehicle device 5.

At Step S105, based on the inputted regeneration-enabled signal, the computing means 51 starts accumulation of the regenerative generation amount. The accumulation is executed based on a regeneration period and transitional states of a generation voltage and charging current during the regeneration.

When the determining means 41 determines that the regeneration-enabled state finishes, the process branches to “YES” at Step S107 and advances to Step S108. This stops outputting of the regeneration-enabled signal, then stopping the computing means 51 from accumulating of regenerative generation amount.

Next, the process advances to Step S109, where a decreased amount of fuel consumption or exhaust emission is computed based on the accumulated amount of the regeneration generated in the regeneration-enabled state. The decreased amount of fuel consumption or exhaust emission is displayed on the displaying means 40. Further, data of the decreased amount is provided to the managing center 6 via the wireless terminal 53 as needed.

A relationship between the regenerative generation amount generated in the regeneration-enabled state and decreased amount of fuel consumption or exhaust emission is differentiated by generator capability, a vehicle weight, engine output, or battery capacity, so that the relationship is previously obtained with respect to each of vehicle types by an experiment or the like.

The ETC in-vehicle device 5 communicates bi-directionally with the wireless terminal 61 of the managing center 6 as needed, and provides the managing center 6 with the decreased amount data relative to the decreased amount of fuel consumption or exhaust emission along with an ID of the vehicle owner 10.

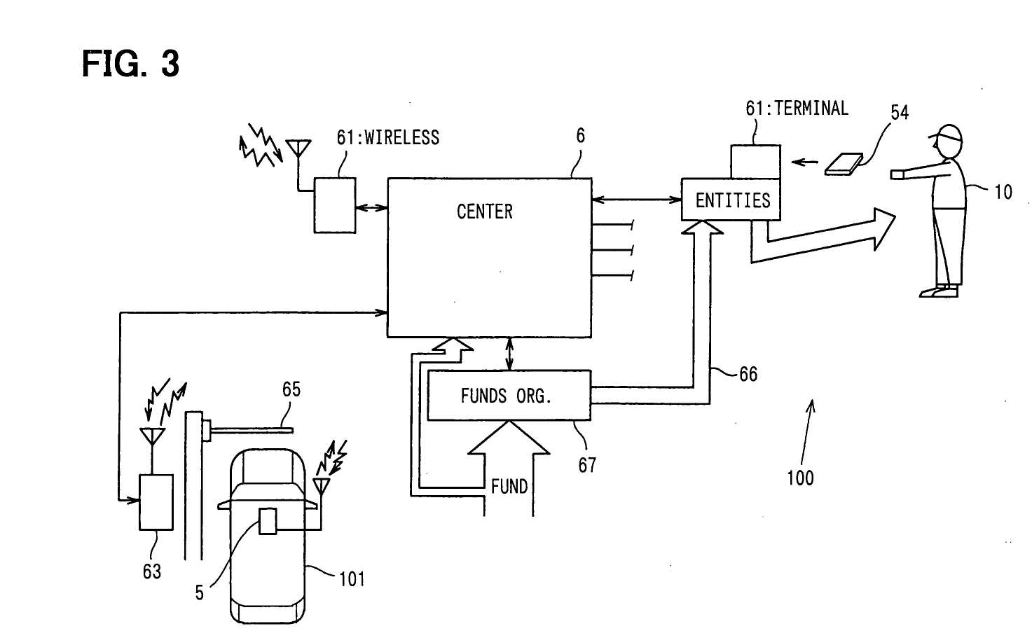

Service provided to the vehicle owner 10 according to the decreased amount data will be explained with reference to FIG. 3. The decreased amount data together with the ID of the vehicle owner 10 is sent to the wireless terminal 61 of a data receiver from the wireless terminal 53 by the bi-directional communications to be updated as needed. In this embodiment, the decreased amount data transmitted to the managing center 6 is an accumulated decreased amount pertinent to fuel consumption or exhaust emission.

The vehicle owner 10 receives a value exchange according to the decreased amount data in a manner to be explained below. Here, the vehicle owner 10 carries an ID card for authorizing the owner himself; the ID card stores the same ID as that of the vehicle owner 10. The ID card can be replaced with inputting of an ID plus password.

A vehicle sales company as a vehicle-related company executes the value exchange as a part or all of a repair charge or maintenance charge of the relevant vehicle or a replacement part, as a privilege to vehicle assessment or as a discount to a divided payment for the relevant vehicle. Further, a gas station as a vehicle-related company executes the value exchange as an in-kind payment for fuel or oil, or as a part or all of a fuel charge, oil charge, or washing charge.

As various associated entities, a restaurant, retail shop, hotel, or amusement park executes the value exchange as a part or all of a food charge, a goods charge, an accommodation charge, or an admission charge. An electric power company executes the value exchange as all, discount, or privilege to an electricity charge of the home or office of the owner 10 that the owner 10 is responsible for paying. The toll road booth executes the value exchange as a part or all of the charge to the toll road.

In the above vehicle-related company, various associated entities, the home or office of the owner 10, an ID reader terminal 62 is disposed for communicating with the managing center 6. When the ID card 54 of the owner 10 is inserted into the ID reader terminal 62, the decreased amount data or money amount exchangeable, etc. relative to the ID is recognized by the ID reader terminal 62.

After each of the various associated entities provides a service or a goods to the owner 10, a discount or value exchange amount preferred by the owner 10 is inputted to the ID reader terminal 62, resulting in subtracting it from the decreased amount data managed in the managing center 6. Here, the discount or the value exchange amount can be determined by the various associated entities.

In the value exchange with the electricity charge, when a discount or value exchange amount preferred by the owner 10 is inputted to the ID reader terminal 62, resulting in discounting the electricity charge and subtracting it from the decreased amount data managed in the managing center 6. Here, the discount or the value exchange amount can be determined by the power company.

In the value exchange with the toll charge to the toll road, since a wireless terminal 63 communicable mutually with the managing center 6 is installed at a booth of the toll road, the toll charge is discount by using a part of the accumulated value of the decreased amount data when the vehicle passes through a gate 65 of the toll road. In this embodiment, a funds organization 67 pays the various associated entities, a power company, an administration (or owner) of the toll road for the money 66 equivalent to the value exchange. The funds organization 67 is founded utilizing the funds provided by the vehicle-related companies and their supporters.

Advantage of the system 100 of this embodiment is as follows: in the regeneration-enabled state where a kinetic energy can be converted into an electric energy without consuming fuel, the controlling means 42 controls the generator 2 so that the regenerative generation amount is increased; in the regeneration-disabled state, the controlling means 42 controls the generator 2 so that the non-regenerative generation amount is restrained. The estimated decreased amount of the fuel consumption or exhaust emission decreased by the above generation increasing control in regeneration and generation decreasing control in other than the regeneration is computed based on the accumulated regenerative generation amount by the computing means 51. The decreased amount data relative to the estimated decreased amount computed is provided to the managing center 6 from the wireless terminal 53 via wireless communications.

When the ID card 54 storing the same ID as that of the owner 10 is communicated with the ID reader terminal 62 in the associated entities and the decreased amount data is provided, the value exchange is executed using the decreased amount data provided. As a result, the owner 10 positively performs driving enabling the regeneration, resulting in contribution to the global environment conservation.

The decreased amount data together with the ID of the owner 10 is provided to the managing center 6 via wireless communications as needed. Accordingly, the decreased amount data does not need updating or rewriting in the vehicle, simplifying a structure of the ID card 54 and the ID reader terminal 62 installed in the associated entities.

The owner 10 can receive a discount to electricity charge without installing equipment for selling electric power; no use of the equipment creates no conversion loss.

The various associated entities, a power company, or an administration of the toll road excluding the vehicle-related companies provides to the owner 10 a value exchange; the money 66 corresponding to the value exchange is paid to the various associated entities etc. by the funds organization. This structure enables the value exchange using the decreased amount data to broadly prevail.

The computing means 51, displaying means 52, and wireless terminal 53 are built in the ETC in-vehicle device 5, so that no additional terminal is required inside the vehicle for providing the decreased amount data to the managing center 6.

In this embodiment, a battery 3 is used as an electric power storage; however, other means such as a capacitor (electric double layer capacitor) can be used as the electric power storage.

(Second Embodiment)

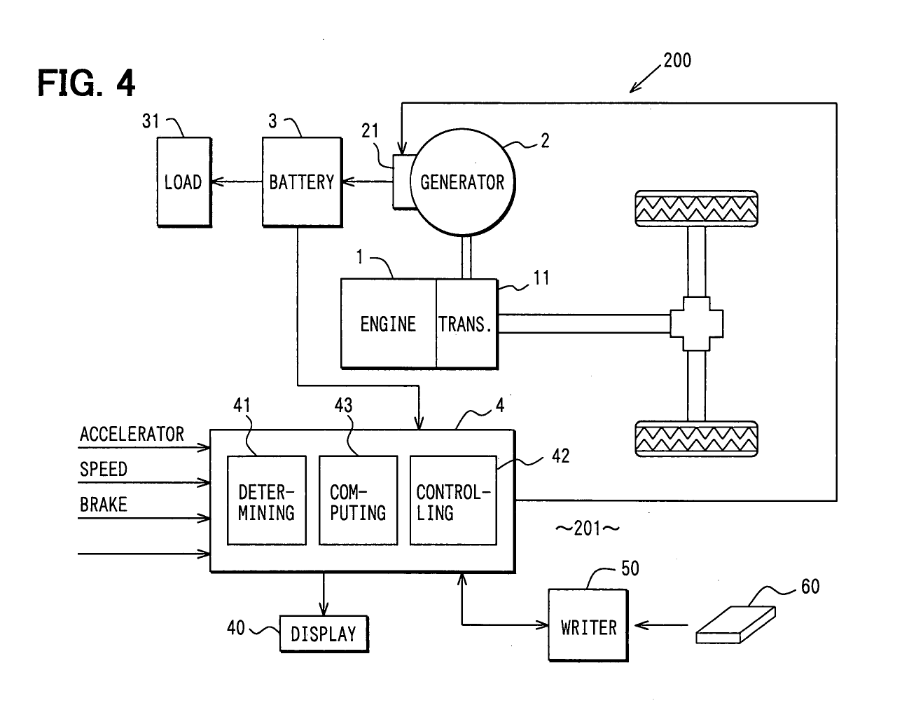

An environment conservation contribution system 200 according to a second embodiment of the present invention will be now explained with reference to FIGS. 4 to 6. The system 200 is different from the system 100 in the following.

A computing means 43 is built in a controller 4, while a displaying means 40 is disposed properly in an instrument panel. In a regeneration-enabled state, a controlling means 42 increases a generation amount so that generation voltage is increased; in a regeneration-disabled state, the controlling means 42 controls the generation amount by returning the generation voltage to a normal level.

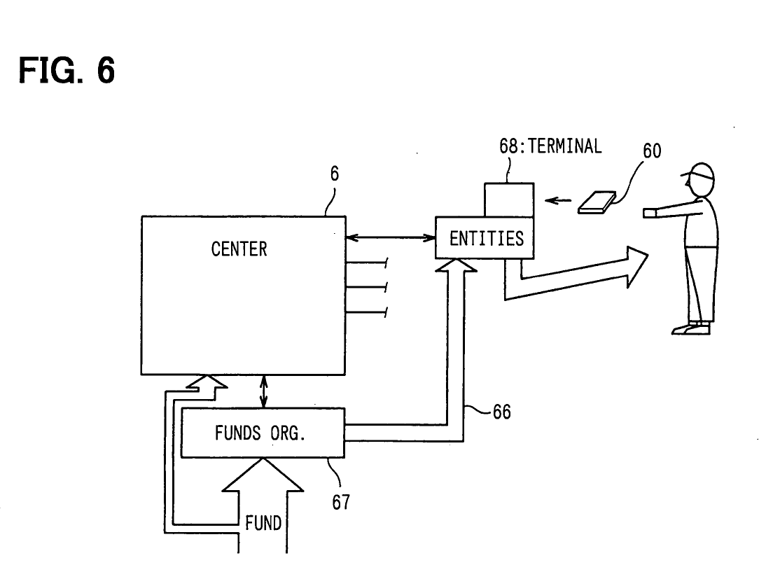

Decreased amount data computed at Step S207, relative to a (accumulated) decreased amount of fuel consumption or exhaust emission is directly written to a data card 60 storing an ID of a vehicle owner 10, by an in-vehicle writer 50 as needed. The data card 60 is disposed in the in-vehicle writer 50 so that consistency with the decreased amount data can be maintained; when leaving the vehicle 201, the owner 10 detaches the data card 60 to carry it. The carried data card 60 is then communicated with a terminal 68 in associated entities in FIG. 6, so that the decreased amount data stored in the data card 60 is provided to the managing center 6.

Service provided to the vehicle owner 10 according to the decreased amount data will be explained with reference to FIG. 6. The vehicle owner 10 receives a value exchange according to the decreased amount data in a manner to be explained below. Here, the vehicle owner 10 carries the data card 60 storing the ID of the owner 10.

A vehicle sales company as a vehicle-related company executes the value exchange as a part or all of a repair charge or maintenance charge of the relevant vehicle or a replacement part, as a privilege to vehicle assessment or as a discount to a divided payment for the relevant vehicle. Further, a gas station as a vehicle-related company executes the value exchange as an in-kind payment for fuel or oil, or as a part or all of a fuel charge, an oil charge, or a washing charge.

As various associated entities, a restaurant, retail shop, hotel, or amusement park executes the value exchange as a part or all of a food charge, a goods charge, an accommodation charge, or an admission charge. An electric power company executes the value exchange as all, discount, or privilege to an electricity charge of the home or office of the owner 10 that the owner 10 is responsible for paying.

In the above vehicle-related company, various associated entities, the home or office of the owner 10, the reader terminal 68 is disposed for communicating with the managing center 6. When the data card 60 of the owner 10 is communicated with the reader terminal 68, the decreased amount data is recognized by the reader terminal 68, being sent to the managing center 6 via a bi-directional communications.

After the various associated entities provide a service or a goods to the owner 10, a discount or value exchange amount preferred by the owner 10 is inputted to the reader terminal 68. The decreased amount data corresponding to the value exchange inputted is then subtracted from the data card 60; the subtracted amount and the remaining amount posterior to subtracting are sent to the managing center 6. Here, the discount or the value exchange amount can be determined by the various associated entities.

In the value exchange with the electricity charge, when a discount or value exchange amount preferred by the owner 10 is inputted to the reader terminal 68, the electricity charge is discounted and the decreased amount data corresponding to the value exchange is subtracted from the data card 60; the subtracted amount and the remaining amount posterior to subtracting are sent to the managing center 6. Here, the discount or the value exchange amount can be determined by the power company.

In this embodiment, a funds organization 67 pays the various associated entities, or power company for the money 66 equivalent to the value exchange. The funds organization 67 is founded utilizing the funds provided by the vehicle-related companies and their supporters.

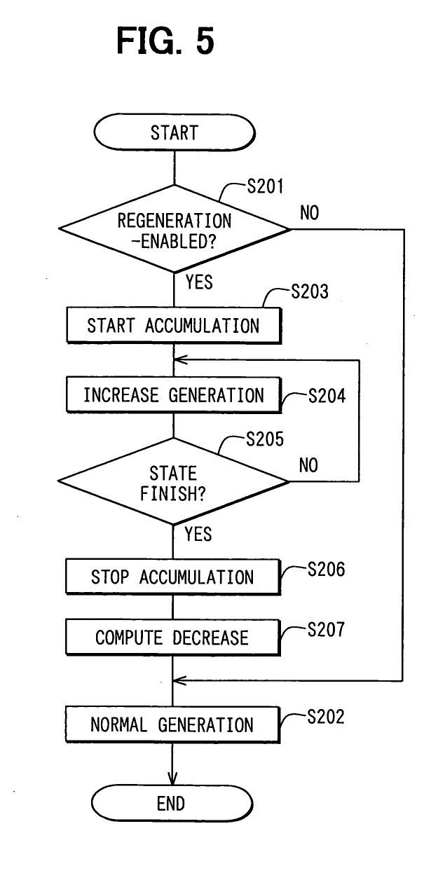

Advantage of the system 200 of this embodiment is as follows. By the generation increasing control taking place in the regeneration-enabled state at Step S204 in FIG. 5, the generation amount in other state is decreased. The decreased amount of the fuel consumption or exhaust emission is thereby estimated based on the accumulated regenerative generation amount by the computing means 43. The decreased amount data relative to the decreased amount estimated is written in the data card 60 storing the owner's ID via the in-vehicle writer 50 as needed. When the data card 60 is communicated with the terminal 68 in the associated entities and the decreased amount data is provided, the value exchange is executed using the decreased amount data provided. As a result, the owner 10 positively performs driving enabling the regeneration, resulting in contribution to the global environment conservation.

Further, the various associated entities, or power company excluding the vehicle-related companies provides to the owner 10 a value exchange; the money 66 corresponding to the value exchange is paid to the various associated entities etc. by the funds organization. This structure enables the value exchange using the decreased amount data to broadly prevail.

(Third Embodiment)

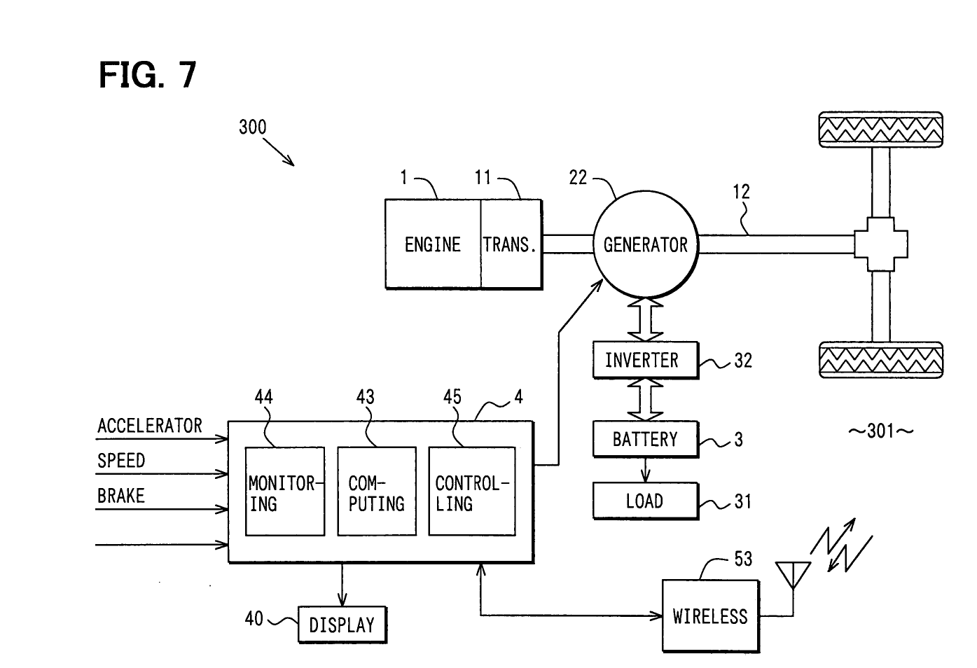

An environment conservation contribution system 300 according to a third embodiment of the present invention will be now explained with reference to FIG. 7. In the system 300, a parallel hybrid vehicle 301 includes an engine 1; a motor generator 22; an in-vehicle battery 3 as an electric power storage storing electric power; an inverter 32; a controller 4 having a state monitoring means 44; a generator controlling means 45 for controlling the motor generator 22, and a decreased amount computing means 43; a displaying means 40; a wireless terminal 53 as a data providing means. Decreased amount data is provided to the managing center 6 via wireless communications. In this embodiment, the decreased amount data is an accumulated amount relative to a decreased amount of fuel consumption or exhaust emission.

The engine 1 is operated using gasoline mounted in the parallel hybrid vehicle 301, primarily producing motive energy for traveling. The motor generator 22 is connected with the engine 1 via a transmission 11, being able to switch between an electromotive operation assisting driving force to a vehicle axis 12 and generating operation generating power by being driven by the engine 1.

The battery 3 accumulates electric power generated by the motor generator 22, providing an electrical load 31 of an in-vehicle electrical component of the parallel hybrid vehicle 301 with operational power. The state monitoring means 44 monitors based on various signals a loading state of the engine 1 and a traveling state of the vehicle 301. The signals include an accelerator opening signal, a vehicle speed signal, and a brake signal.

The generator controlling means 45 controls the motor generator 22 based on the loading state of the engine 1 and the traveling state of the vehicle 301.

Under Low Load State of Engine

Under a low load state of the engine 1 such as constant speed traveling, the motor generator 22 is controlled so that the motor generator 22 executes the generating operation. Thus, the battery 3 is charged owing to the power generated by the motor generator 22, so that the battery 3 maintains a given charging state.

Under High Load State of Engine

Under a high load state of the engine 1 such as starting or accelerating state, the motor generator 22 is controlled so that the motor generator 22 executes the electromotive operation and the electromotive operation assists the driving force for traveling to the vehicle axis 12.

Under Regeneration-Enabled State

Under a regeneration-enabled state, the motor generator 22 is controlled so that the motor generator 22 executes the large amount generating operation and the battery 3 becomes fully charged. The regeneration-enabled state means a state where a foot is separated from an accelerator, e.g., corresponding to running by inertia, decelerating, braking, and descending.

The computing means 43 starts accumulation of the regenerative generation amount after the power regeneration is started owing to shifting to the regeneration-enabled state, while the means 43 stops the accumulation, after the power regeneration is stopped. The decreased amount of fuel consumption or exhaust emission is computed based on the accumulated regenerative generation amount generated under the regeneration-enabled state. The decreased amount computed is displayed on a proper area of the instrument panel by the displaying means 40. Data of the decreased amount is provided to the managing center 6 via the wireless terminal 53 as needed. This enables the owner 10 to receive services according to the decreased amount data relative to the decreased amount of fuel consumption or exhaust emission.

A relationship between the regenerative generation amount generated in the regeneration-enabled state and decreased amount of fuel consumption or exhaust emission is differentiated by generator capability, a vehicle weight, engine output, or battery capacity, so that the relationship is previously obtained with respect to each of vehicle types by an experiment or the like.

Advantage of the system 300 of this embodiment is as follows. Under the regeneration-enabled state, the motor generator 22 is controlled so that the motor generator 22 executes the large amount generating operation and the battery 3 becomes fully charged. The decreased amount of the fuel consumption or exhaust emission is estimated based on the accumulated regenerative generation amount by the computing means 43. The decreased amount data relative to the decreased amount estimated is provided to the managing center 6 from the wireless terminal 53 via wireless communications. Similarly with the system 100, when an ID card storing the same ID as that of the owner 10 is communicated with an ID card reader terminal in the associated entities and the decreased amount data is provided, the value exchange is executed using the decreased amount data provided. As a result, the owner 10 positively performs driving enabling the regeneration, resulting in contribution to the global environment conservation.

(Fourth Embodiment)

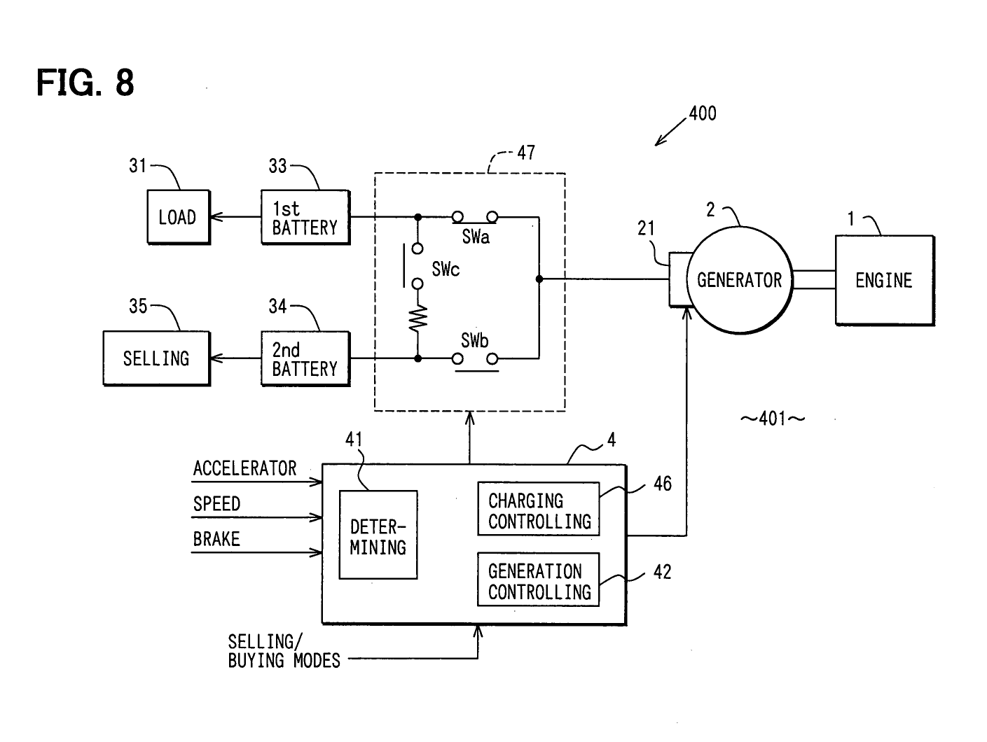

A regeneration power utilization system 400 according to a fourth embodiment of the present invention will be now explained with reference to FIGS. 8 to 10. The system 400 includes an in-vehicle engine 1; an in-vehicle generator 2 connected with and driven by the engine 1; a first in-vehicle battery 33; a second in-vehicle battery 34; and a controller 4 having a regenerative generation determining means 41, a generation controlling means 42, and a charging controlling means 46.

The engine 1 is operated using gasoline mounted in a vehicle 401, primarily producing motive energy for traveling. The generator 2 is an alternator enabling variation of the generation amount by varying exciting current, being connected with the engine 1 via a transmission. The first battery 33 stores electric power generated by the generator 2, supplying electrical loads 31 such as in-vehicle electronic devices with operational power. The second battery 34 stores electric power generated by the power regeneration of the generator 2.

The regenerative generation determining means 41 monitors based on various signals a traveling state of the vehicle 401 to determine whether the power regeneration is possible or not. The regeneration-enabled state means a state where a foot is separated from an accelerator, e.g., corresponding to running by inertia, decelerating, braking, and descending.

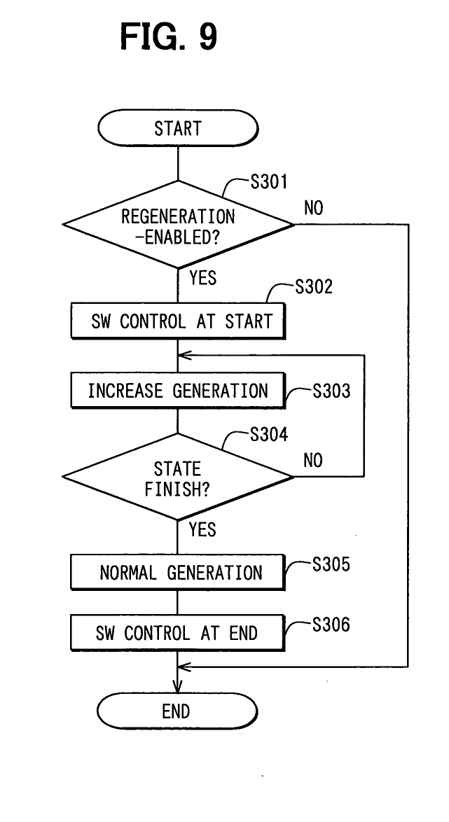

When it is determined that a regeneration-enabled traveling state is allowed at Step S301 in FIG. 9, the generation controlling means 42 increases a generation amount of the generator 2 to thereby charge the second battery 34 after switch control at regeneration start is completed at Step S302. The generation amount of the generator 2 is increased within a range of the exciting current up to an upper limit corresponding to large generation by instructing a regulator 21 to increase generation voltage.

By contrast, under the regeneration-disabled traveling state, the regulator 21 is instructed to execute normal generation to thereby charge the first battery 33 as shown in Steps S305 to S306 in FIG. 9.

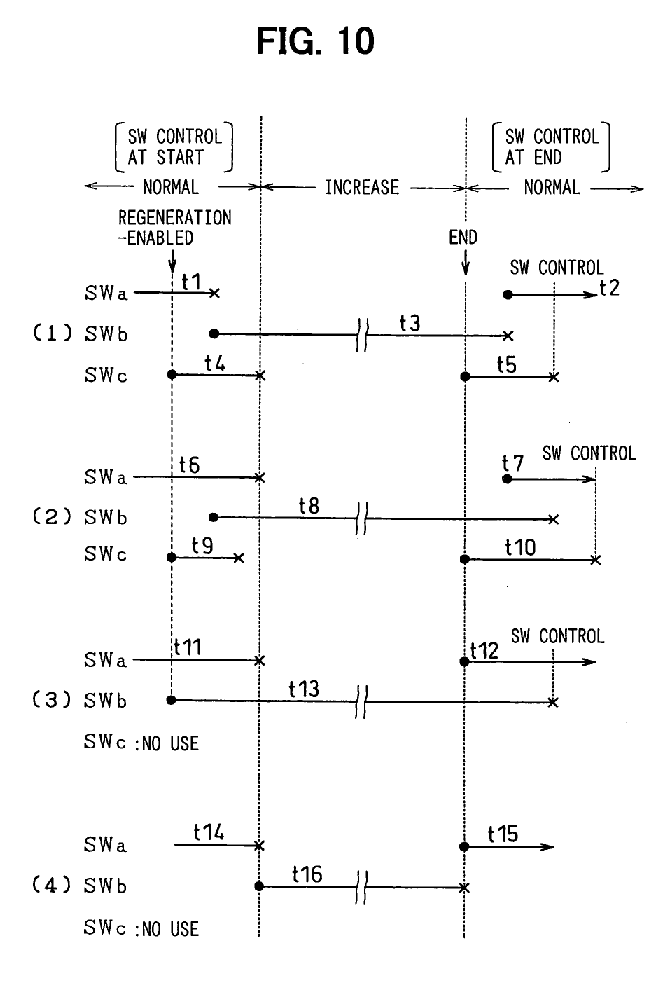

The charging controlling means 46 executes the switch control at regeneration start shown at Step S302 to switch large capacity contacts SWa, SWb, SWc of a relay 47 at any one of timings shown in the left side in (1) to (3) in FIG. 10. Switch control at regeneration end shown at Step S306 is executed to switch the large capacity contacts SWa, SWb, SWc of the relay 47, similarly, at any one of timings shown in the right side in (1) to (3) in FIG. 10.

At the timing shown in (1) in FIG. 10, the large capacity contact SWa is closed (turned ON) during a period t1 and a period t2; SWb is turned ON, t3; SWc is turned ON, t4, t5.

At the timing shown in (2) in FIG. 10, the large capacity contact SWa is turned ON during a period t6 and a period t7; SWb is turned ON, t8; SWc is turned ON, t9, t10.

At the timing shown in (3) in FIG. 10, the large capacity contact SWa is turned ON during a period t 1 and a period t12; SWb is turned ON, t13.

At the timing shown in (4) in FIG. 10, the large capacity contact SWa is turned ON during a period t14 and a period t15; SWb is turned ON, t16.

As explained above, the charging controlling means 46 controls the switch control at start and end of the regeneration. It is because difference exists between the first and second batteries 33, 34 in their charge capacity (typically charge capacity of the first battery 33 is lower than that of the second 34) and no load at moment is prevented. Therefore, the timing shown in (4) in FIG. 10 is unfavorable.

Thus, the second battery 34 can be thereby charged owing to regenerative generation power generated by the generator 2 under the regeneration-enabled state, while the first battery 33 can be charged, under other than the regeneration-enabled state. The electric power accumulated in the second battery 34 can be sold via a power-selling device 35, which utilizes the regeneration power. Here, it is not designed that the electric power accumulated by the first battery 33 that is necessary for traveling is mistakenly sold.

(Fifth Embodiment)

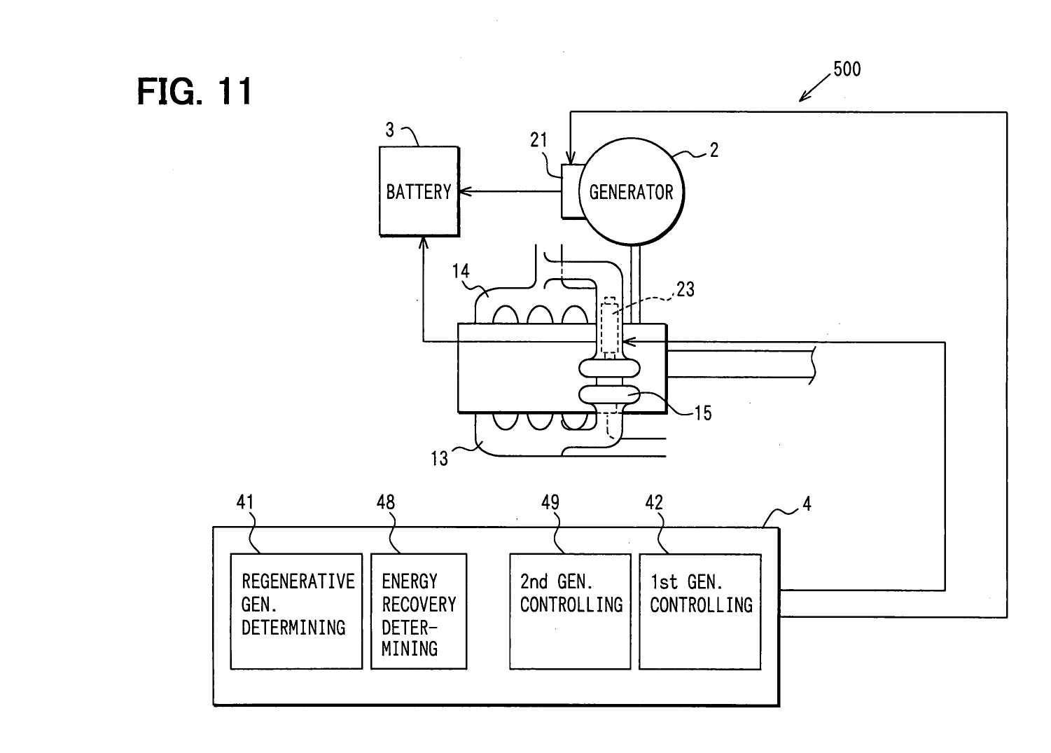

An environment conservation contribution system 500 according to a fifth embodiment of the present invention will be now explained with reference to FIG. 11. The system 500 includes a supercharger 15 for supercharging an inlet air by exhaust gas or exhaust energy of an engine 1 and further includes a second generator 23 coaxially linked with the supercharger 15. A controller 4 further includes an energy recovery determining means 48 and a second generation controlling means 49 in addition to a regenerative generation determining means 41 and a (first) generation controlling means 42. When the energy recovery determining means 48 determines that energy recovery is allowed, the first generation controlling means 42 stops the first generator 2 and the second generation controlling means 49 causes the second generator 23 to generate (or execute regenerative generation) at a full load. Here, the generator 2 driven by the output axis of the engine 1 is stopped, so that fuel for generation is decreased. While the generator 2 is stopping, electric power supply is executed by the second generator 23 driven by the exhaust energy. Thus, fuel consumption is thereby decreased, so that value exchange with which an owner is rewarded is increased.

Furthermore, a means for converting the exhaust energy to electric energy can include a thermoelectric element such as Peltier element. Here, when the thermoelectric element is in an active state (i.e., generating electric power), the generator 2 can be stopped, which further decreases a fuel consumption amount.

(Modification and Others)

The wireless terminal 53 can include a dedicated wireless device, a cell phone, or a personal handy phone (PHS). The ID card 54 storing an ID of an owner 10 can be a known credit card.

In the environment conservation contribution system 100, 200, 300, 500, when an vehicle idling operation continuing for more than a predetermined period takes place, an increased amount of fuel consumption or exhaust emission corresponding to the idling operation can be computed and to be subtracted from the decreased amount computed by the decreased amount computing means.

The managing center 6 can also store occurrence and usage history of the exhaust emission amount data and have an agreement with vehicle-related companies on providing them. Further, the funds organization can be provided with a subsidy by a government, an autonomous body, or a local public entity.

In the environment conservation contribution system 200, a decreased amount computing means is removed from the controller 4 and can be built in an additional in-vehicle device disposed in a vehicle 201 along with an in-vehicle writer 50, and a displaying means 40.

A decreased amount of fuel consumption or exhaust emission decreased by the generation increasing control in regeneration can be computed in the managing center 6. Here, it is favorable that the center 6 is notified of the decreased amount data at the end of driving or operation and at the subsequent start of driving or operation of a relevant vehicle.

An alternator can be structured to be driven by a crank pulley of an engine via a belt.

A hybrid vehicle can be structured to be series-hybrid.

Thus, a function that provides decreased amount data to a managing center is installed in a vehicle or in-vehicle device mounted in a vehicle. Producing or selling the above vehicle or in-vehicle device facilitates environment conservation contribution system, which effectively utilizes energy and contributes to conservation of global environment.

It will be obvious to those skilled in the art that various changes may be made in the above-described embodiments of the present invention. However, the scope of the present invention should be determined by the following claims.

1. An environment conservation contribution system using a vehicle, the system comprising:
certain generating means disposed in the vehicle for executing regenerative generation;
electric power accumulating means disposed in the vehicle for accumulating electric power owing to at least the regenerative generation executed by the certain generating means and for functioning as a supply source of operational electric power for an electric load disposed in the vehicle;
regenerative generation determining means disposed in the vehicle for monitoring a state of the vehicle and for determining whether the regenerative generation executed by the certain generating means is allowed under the state monitored;
generation controlling means disposed in the vehicle for causing the certain generating means to execute the regenerative generation when the regenerative generation is determined to be allowed under the state monitored; and
data providing means disposed in the vehicle for providing, to a managing center outside the vehicle, regeneration data corresponding to the regenerative generation executed.

2. The environment conservation contribution system of claim 1, further comprising:
an engine disposed in the vehicle for operating using fuel stored in the vehicle, primarily producing a motive energy for traveling of the vehicle;
given generating means disposed in the vehicle and driven by the engine for executing non-regenerative generation;
decreased amount computing means disposed in the vehicle for computing decreased amount data corresponding to a fuel consumption amount or an exhaust emission amount that is estimated to be decreased by the regenerative generation,
wherein the data providing means provides the decreased amount data computed to the managing center.

3. The environment conservation contribution system of claim 1, further comprising:
an engine disposed in the vehicle for operating using fuel stored in the vehicle, primarily producing a motive energy for traveling of the vehicle;
given generating means disposed in the vehicle and driven by the engine for executing non-regenerative generation, wherein the generation controlling means executes a generation increasing control that controls the certain generating means so that a generation amount is increased when the regenerative generation is determined to be allowed under the state monitored and a generation decreasing control that controls the given generating means so that the generation amount is decreased when the regenerative generation is determined to be not allowed under the state monitored; and
decreased amount computing means disposed in the vehicle for computing decreased amount data corresponding to a fuel consumption amount or an exhaust emission amount that is estimated to be decreased by the generation increasing control and the generation decreasing control,
wherein the data providing means provides the decreased amount data computed to the managing center.

4. The environment conservation contribution system of claim 3,
wherein the certain generating means and the given generating means included in a generator.

5. The environment conservation contribution system of claim 1,
wherein the certain generating means is included in a motor generator that also functions as an electric motor.

6. The environment conservation contribution system of claim 1, further comprising:
an engine disposed in the vehicle for operating using fuel stored in the vehicle, primarily producing a motive energy for traveling of the vehicle; and
given generating means disposed in the vehicle and driven by the engine for executing non-regenerative generation,
wherein the certain generating means and given generation means is included in a generator that is an alternator being able to be varied in a generation amount by varying exciting current,
wherein the electric power accumulating means accumulates electric power owing to generation executed by the generator,
wherein, when a charging level of the electric power accumulating means is not less than a given level under the state where the regenerative generation is not allowed, the generation controlling means sets an upper limit of the exciting current of the generator to a first upper limit, and
wherein, when the charging level of the electric power accumulating means is less than the given level under the state where the regenerative generation is not allowed, the generation controlling means sets the upper limit of the exciting current of the generator to a second upper limit being greater than the first upper limit.

7. The environment conservation contribution system of claim 2,
wherein, when the vehicle executes an idling operation for more than a given period, an increased amount of the fuel consumption or the exhaust emission owing to the idling operation is subtracted from the fuel consumption amount or the exhaust emission amount that is estimated to be decreased by the regenerative generation, respectively.

8. The environment conservation contribution system of claim 2, further comprising:
exhaust energy recovering means for recovering energy of an exhaust of the engine by converting the energy recovered into electric energy,
wherein, while the energy recovered is converted into the electric energy, the generation controlling means causes the given generating means to stop the generation to decrease the fuel consumption in the engine.

9. The environment conservation contribution system of claim 8,
wherein the exhaust energy recovering means includes the certain generating means and is linked with an axis of a supercharger of the engine.

10. The environment conservation contribution system of claim 8,
wherein the exhaust energy recovering means includes a thermoelectric converting element disposed within an exhaust pipe of the engine.

11. The environment conservation contribution system of claim 1,
wherein the data providing means is a writer terminal and enables the regeneration data to be written in a portable data storage storing identification data indicating an owner of the vehicle, and
wherein the regeneration data is provided to the managing center via the writer terminal that is communicating with the portable data storage.

12. The environment conservation contribution system of claim 1,
wherein the data providing means includes one of an in-vehicle type and a portable type,
wherein the data providing means provides, using wireless communications, identification data indicating an owner of the vehicle along with the regeneration data to the managing center, and
wherein the identification data along with the regeneration data is received by a data receiver in the managing center.

13. The environment conservation contribution system of claim 1,
wherein accumulated regeneration data is formed in the managing center by accumulating the regeneration data provided from the vehicle or the accumulated regeneration data is provided to the managing center from the vehicle as the regeneration data that is formed by accumulating, in the vehicle, the regenerative generation executed, and
wherein one of vehicle-related companies obtains the accumulated regeneration data from the managing center and provides an owner of the vehicle with a value relative to the accumulated regeneration data.

14. The environment conservation contribution system of claim 13,
wherein the data providing means is included in an in-vehicle device used for an electronic toll collection system,
wherein the regeneration data is provided to the managing center via an intermediary device that is disposed in a toll collection area when the vehicle passes through the toll collection area, a toll charge is discounted by a discount according to the accumulated regeneration data, and
wherein the discount is returned to an owner of the electronic toll collection system from a funds organization established by the vehicle-related companies and supporting companies.

15. The environment conservation contribution system of claim 13,
wherein the value relative to the accumulated regeneration data includes a discount or a privilege to one of a repair charge, a maintenance charge of the vehicle, a replacement part of the vehicle, vehicle assessment, and a divided payment for purchasing the vehicle.

16. The environment conservation contribution system of claim 13,
wherein the data providing means is a writer terminal that is disposed in the vehicle and enables the regeneration data to be written in a portable card-type storage storing identification data indicating an owner of the vehicle, and
wherein the regeneration data is provided to the managing center via the writer terminal that is communicating with the portable card-type storage,
wherein the value relative to the accumulated regeneration data is exchanged in an associated entity including one of a restaurant, a retail shop, a hotel, and an amusement park, where a given terminal is disposed for communicating with the portable card-type storage, and
wherein the value relative to the accumulated regeneration data is returned to the associated entity from a funds organization established by the vehicle-related companies and supporting companies.

17. The environment conservation contribution system of claim 13,
wherein the value relative to the accumulated regeneration data is a discount or a privilege to an electricity charge of a home or an office of an owner of the vehicle,
wherein the discount or the privilege is returned to an electricity company from a funds organization established by the vehicle-related companies and supporting companies.

18. An in-vehicle device provided in a vehicle, comprising:
certain generating means for executing regenerative generation;
electric power accumulating means for accumulating electric power owing to at least the regenerative generation executed by the certain generating means and for functioning as a supply source of operational electric power for an electric load disposed in the vehicle;
regenerative generation determining means for monitoring a state of the vehicle and for determining whether the regenerative generation executed by the certain generating means is allowed under the state monitored;
generation controlling means for causing the certain generating means to execute the regenerative generation when the regenerative generation is determined to be allowed under the state monitored; and
data providing means for providing, to a managing center outside the vehicle, regeneration data corresponding to the regenerative generation executed.

19. The in-vehicle device of claim 18, further comprising:
an engine for operating using fuel stored in the vehicle, primarily producing a motive energy for traveling of the vehicle;
given generating means driven by the engine for executing non-regenerative generation; and
decreased amount computing means for computing decreased amount data corresponding to a fuel consumption amount or an exhaust emission amount that is estimated to be decreased by the regenerative generation,
wherein the data providing means provides the decreased amount data computed to the managing center.

20. A regenerative generation utilization system using a vehicle, comprising:
an engine disposed in the vehicle for operating using fuel stored in the vehicle, primarily producing a motive energy for traveling of the vehicle;
a generator disposed in the vehicle and driven by the engine for executing generation of non-regenerative generation and regenerative generation;
first electric power accumulating means disposed in the vehicle for accumulating electric power owing to the non-regenerative generation executed by the generator and for functioning as a supply source of operational electric power for an electric load disposed in the vehicle;
second electric power accumulating means disposed in the vehicle for accumulating electric power owing to the regenerative generation executed by the generator;
regenerative generation determining means disposed in the vehicle for monitoring a state of the vehicle and for determining whether the regenerative generation executed by the generator is allowed under the state monitored;
charging controlling means disposed in the vehicle for switching between first control and second control, wherein the first control is for causing the generator to execute the regenerative generation that is charged to the second electric power accumulating means when the regenerative generation is determined to be allowed under the state monitored, and the second control is for causing the generator to execute the non-regenerating generation that is charged to the first electric power accumulating means when the regenerative generation is determined to be not allowed under the state monitored; and
generation controlling means for controlling a generation amount of the generator so that the first and second electric power accumulating means maintain their charging states, and for causing the generator to increase the generation amount when the regenerative generation is determined to be allowed under the state monitored,
wherein the accumulated electric power of the second electric power accumulating means is sold.

21. A method for returning a value of regenerative generation, comprising steps of:
computing an amount of regenerative generation by an in-vehicle generator;
determining an economic value according to the amount of the regenerative generation computed;
accepting a payment request from a person having a right for using the economic value determined; and
causing the person to use the economic value determined.

22. A method for returning a value of regenerative generation, comprising steps of:
computing an amount of regenerative generation by an in-vehicle generator;
converting the amount of the regenerative generation computed to one of decreased amounts of fuel consumption and exhaust emission;
determining an economic value according to the one of decreased amounts to which the amount of the regenerative generation computed is converted;
accepting a payment request from a person having a right for using the economic value determined; and
causing the person to use the economic value determined.

23. The method for returning a value of regenerative generation of claim 21, further comprising a step of:
sending data corresponding to the amount of the regenerative generation computed from an in-vehicle device to a stationary base station, before the step of causing the person to use the economic value determined according to the computed amount of the regenerative generation.
